(19) United States
(12) Patent Application Publication
(10) Pub. No.: US 2007/0126978 A1
(43) Pub. Date: Jun. 7, 2007

(54) Diving Viewing Device

(76) Inventor: David Morales, Orlando, FL (US)

Correspondence Address: SEAN KAUFHOLD, P. O. BOX 89626, SIOUX FALLS, SD, 57109, US

(21) Appl. No.: 11/684,938

(22) Filed: Mar. 12, 2007

(51) Int. Cl. G02C 7/14

(52) U.S. Cl. 351/50

(57) ABSTRACT

A diving viewing device for permitting a diver to view behind the diver to observe any predatory fish approaching from the rear includes a diving mask being wearable over eyes of a diver to permit the diver to see under water. A pair of rear viewing assemblies is coupled to the diving mask. Each of the rear viewing assemblies is extendable from the diving mask to permit the diver wearing the diving mask to look at the rear viewing assemblies to see behind the diver. The rear viewing assemblies are positioned on opposing sides of the diving mask.

### BACKGROUND OF THE INVENTION

1. Field of the Invention

The present invention relates to rear view diving mirrors and more particularly pertains to a new rear view diving mirror for permitting a diver to view behind the diver to observe any predatory fish approaching from the rear.

2. Description of the Prior Art

The use of rear view diving mirrors is known in the prior art. While these devices fulfill their respective, particular objectives and requirements, the need remains for a device that has certain improved features that allow for rear viewing assemblies of the device to be adjusted to provide optimal viewing for a diver wearing the device. Additionally, the device should include a pair of rear viewing assemblies to reduce the chances of a predatory fish approaching from a blind spot.

### SUMMARY OF THE INVENTION

The present invention meets the needs presented above by generally comprising a diving mask being wearable over eyes of a diver to permit the diver to see under water. A pair of rear viewing assemblies is coupled to the diving mask. Each of the rear viewing assemblies is extendable from the diving mask to permit the diver wearing the diving mask to look at the rear viewing assemblies to see behind the diver. The rear viewing assemblies are positioned on opposing sides of the diving mask.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a diving viewing device according to the present invention.

FIG. 2 is a side view of the present invention.

FIG. 3 is a front view of the present invention.

FIG. 4 is a cross-sectional view of the present invention taken along line 4-4 of FIG. 2.

FIG. 5 is a rear perspective view of the present invention shown in use.

### DESCRIPTION OF THE PREFERRED EMBODIMENT

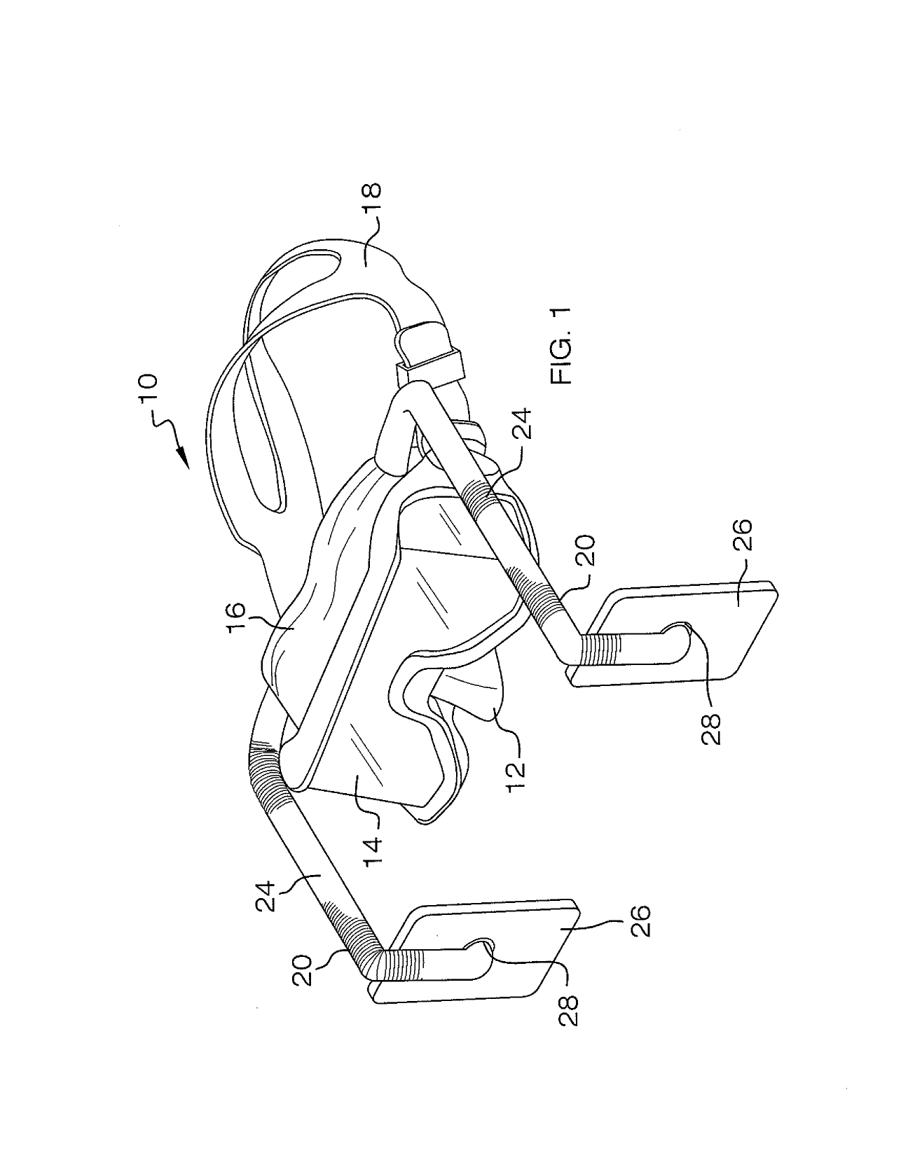

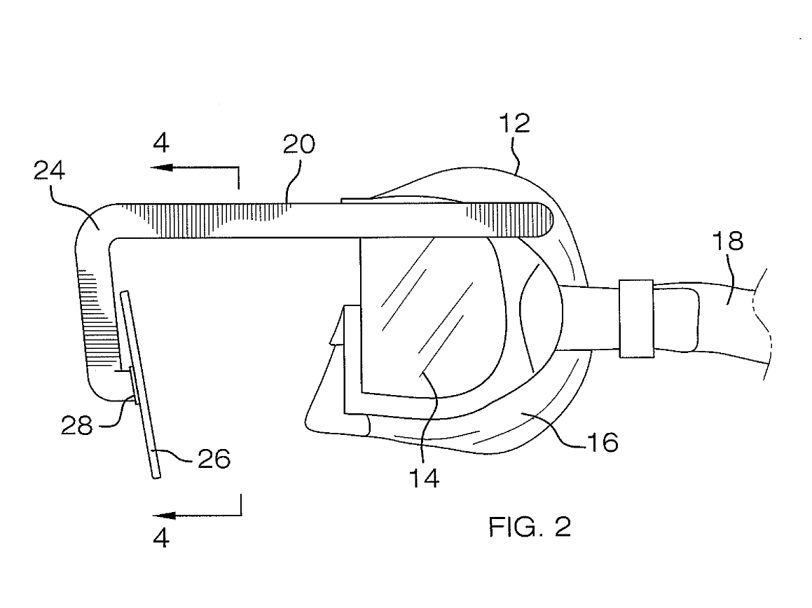

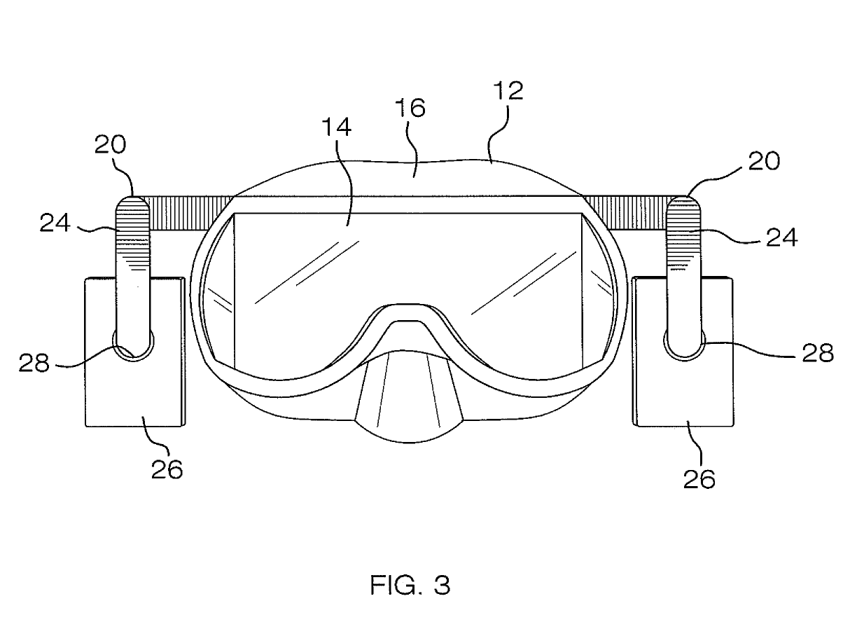

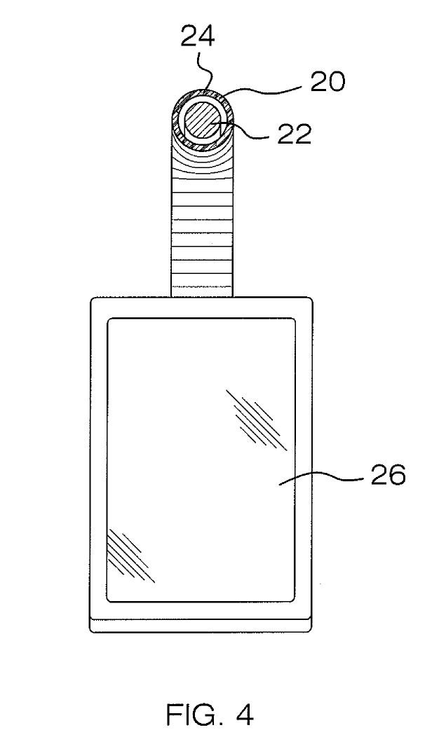

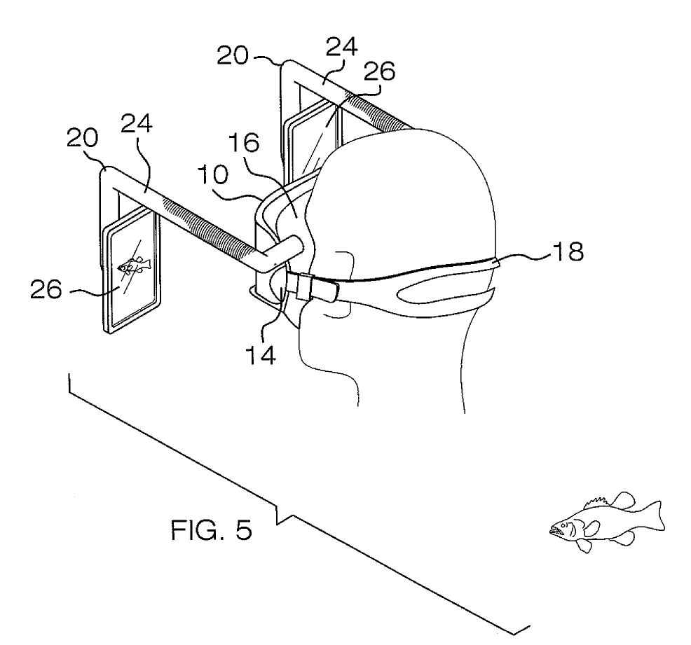

With reference now to the drawings, and in particular to FIGS. 1 through 5 thereof, a new rear view diving mirror embodying the principles and concepts of the present invention and generally designated by the reference numeral 10 will be described.

As best illustrated in FIGS. 1 through 5, the diving viewing device 10 generally comprises a diving mask 12 being wearable over eyes of a diver to permit the diver to see under water. The diving mask 12 has a length of approximately 8 inches and a width of approximately 4 inches. The diving mask 12 includes a lens 14 comprised of a transparent material to permit viewing through the lens 14. The diving mask 12 includes a seal 16 mounted to and extending around the lens 14. The seal 16 is pressed against a face of the diver to provide a watertight seal to inhibit water entering the diving mask 12. A strap 18 is coupled to the diving mask 12. The strap 18 extends around a back of a head of the diver to secure the diving mask 12 and force the seal 16 against the head of the diver.

A pair of rear viewing assemblies 20 is coupled to the diving mask 12. Each of the rear viewing assemblies 20 is extendable from the diving mask 12 to permit the diver wearing the diving mask 12 to look at the rear viewing assemblies 20 to see behind the diver. The rear viewing assemblies 20 is positioned on opposing sides of the diving mask 12. Each of the rear viewing assemblies 20 includes a support bar 22 coupled to the diving mask 12. The support bar 22 is comprised of a resiliently flexible material to permit bending of the support bar 22 to selectively position the associated one of the rear viewing assemblies 20. The support bar 22 has an overall length between approximately 18 inches and approximately 20 inches.

Each of the rear viewing assemblies 20 also includes a sleeve 24 positioned around the support bar 22. The sleeve 24 is water resistant to minimize contact between water and the support bar 22. The sleeve 24 is comprised of a flexible material to permit the sleeve 24 to conform to a shape of the support bar 22 when the support bar 22 is bent. A mirror 26 is coupled to a free end 28 of the support bar 22. The mirror 26 is directed rearward of the lens 14 and permits the diver to look into the mirror 26 and view an area behind the diver. The mirror 26 is selectively repositioned to a desired position when the support bar 22 is selectively bent. The mirror 26 has a length of approximately 5 inches and a width of approximately 2-½ inches.

In use, the diving mask 12 is positioned over the eyes and the strap 18 extended around the back of the head to secure the diving mask 12 to the head. The diver then grips the mirror 26 of one of the rear viewing assemblies 20 and repositions the mirror 26 to permit viewing to the rear of the diver. While swimming the diver can then look into the mirrors 26 and view behind diver to permit the diver to observe a predatory fish that may be approaching from the rear.

With respect to the above description then, it is to be realized that the optimum dimensional relationships for the parts of the invention, to include variations in size, materials, shape, form, function and manner of operation; assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A diving viewing device for permitting a diver to see to a rear of the diver, said device comprising:
a diving mask being wearable over eyes of the diver to permit the diver to see under water; and
a pair of rear viewing assemblies being coupled to said diving mask, each of said rear viewing assemblies being extendable from said diving mask to permit the diver wearing said diving mask to look at said rear viewing assemblies to see behind the diver, said rear viewing assemblies being positioned on opposing sides of said diving mask.

2. The device according to claim 1, wherein said diving mask includes a lens being comprised of a transparent material to permit viewing through said lens.

3. The device according to claim 2, wherein said diving mask includes a seal mounted to and extending around said lens, said seal being pressed against a face of the diver to provide a watertight seat to inhibit water entering said diving mask.

4. The device according to claim 1, wherein each of said rear viewing assemblies includes a support bar being coupled to said diving mask, said support bar being comprised of a resiliently flexible material to permit bending of said support bar to selectively position the associated one of said rear viewing assemblies.

5. The device according to claim 4, wherein each of said rear viewing assemblies includes a sleeve being positioned around said support bar, said sleeve being water resistant to minimize contact between water and said support bar.

6. The device according to claim 5, wherein said sleeve is comprised of a flexible material to permit said sleeve to conform to a shape of said support bar when said support bar is bent.

7. The device according to claim 4, wherein each of said rear viewing assemblies includes a mirror being coupled to a free end of said support bar, said mirror being directed rearward of a lens of the diving mask and permitting the diver to look into said mirror and view an area behind the diver, said mirror being selectively repositioned to a desired position when said support bar is selectively bent.

7. The device according to claim 1, further comprising a strap being coupled to said diving mask, said strap extending around a back of a head of the diver to secure said diving mask to the head of the diver.

8. A diving viewing device for permitting a diver to see to a rear of the diver, said device comprising:
a diving mask being wearable over eyes of the diver to permit the diver to see under water, said diving mask including a lens being comprised of a transparent material to permit viewing through said lens, said diving mask including a seal mounted to and extending around said lens, said seal being pressed against a face of the diver to provide a watertight seal to inhibit water entering said diving mask;
a pair of rear viewing assemblies being coupled to said diving mask, each of said rear viewing assemblies being extendable from said diving mask to permit the diver wearing said diving mask to look at said rear viewing assemblies to see behind the diver, said rear viewing assemblies being positioned on opposing sides of said diving mask, each of said rear viewing assemblies comprising;
a support bar being coupled to said diving mask, said support bar being comprised of a resiliently flexible material to permit bending of said support bar to selectively position the associated one of said rear viewing assemblies;
a sleeve being positioned around said support bar, said sleeve being water resistant to minimize contact between water and said support bar, said sleeve being comprised of a flexible material to permit said sleeve to conform to a shape of said support bar when said support bar is bent;
a mirror being coupled to a free end of said support bar, said mirror being directed rearward of the lens and permitting the diver to look into said mirror and view an area behind the diver, said mirror being selectively repositioned to a desired position when said support bar is selectively bent; and
a strap being coupled to said diving mask, said strap extending around a back of a head of the diver to secure said diving mask and force said seal against the head of the diver.
